(19) United States
(12) Patent Application Publication
(10) Pub. No.: US 2026/0100426 A1
(43) Pub. Date: Apr. 9, 2026

(54) POWER STORAGE ELEMENT

(71) Applicant: TDK Corporation, Tokyo (JP)

(72) Inventors: Hiroki KITAMURA, Tokyo (JP); Yukiko HIRABAYASHI, Tokyo (JP); Keitaro OTSUKI, Tokyo (JP)

(73) Assignee: TDK Corporation, Tokyo (JP)

(21) Appl. No.: 19/417,436

(22) Filed: Dec. 12, 2025

Related U.S. Application Data
(63) Continuation of application No. PCT/JP2023/024612, filed on Jul. 3, 2023.

(51) Int. Cl. H01M 10/42; H01M 4/02; H01M 4/133; H01M 4/583; H01M 4/62

(52) U.S. Cl. CPC H01M 10/4235; H01M 4/133; H01M 4/583; H01M 4/623; H01M 2004/021; H01M 2004/027

(57) ABSTRACT

A power storage element comprises a negative electrode that includes a first conductor having a first surface and a second surface opposite to the first surface; a first active material layer provided on the first surface of the first conductor and configured to contain a plurality of first negative-electrode active material particles; and a first layer containing an inorganic material and including a first part provided across two or more of the first negative-electrode active material particles exposed on an opposite side of the first conductor, and a second part penetrating between the first negative-electrode active material particles of the first active material layer from the first part.

### CROSS-REFERENCE TO RELATED APPLICATION

This application is a continuation application of International Application No. PCT/JP2023/024612, filed Jul. 3, 2023, the entire contents of which are incorporated herein by reference.

### TECHNICAL FIELD

The present disclosure relates to a power storage element.

### BACKGROUND ART

Lithium-ion secondary batteries are widely used as motive power sources for mobile devices such as portable phones and notebook computers, as well as for hybrid cars. Moreover, in recent years, demand has been increasing for larger batteries, such as stationary power storage systems and electric vehicles, and higher performance that achieves both higher capacity and safety is required.

Patent Literature 1 (WO/2018/168075A1) discloses that gas generation can be suppressed and safety can be improved by forming an intermediate layer including at least one of a fluororesin and particles between a positive electrode and a separator, and by using a specific fluorine-based binder in the positive electrode.

Patent Literature 2 (Japanese Patent Translation Publication No. 2008-506244A) discloses an electrochemical element that can ensure high capacity, long life, and safety by forming a multi-component oxide coating layer on a surface of an electrode active material.

### CITATION LIST

### Patent Literature

[Patent Literature 1] PCT International Publication No. WO/2018/168075
[Patent Literature 2] Japanese Unexamined Patent Publication No. 2008-506244

### SUMMARY OF DISCLOSURE

However, there is room for improvement in cycle characteristics of a power storage element when used at high temperatures.

In one embodiment, a power storage element including:
a negative electrode that includes
a first conductor having a first surface and a second surface opposite to the first surface;
a first active material layer provided on the first surface of the first conductor and configured to contain a plurality of first negative-electrode active material particles; and
a first layer containing an inorganic material and including a first part provided across two or more first negative-electrode active material particles exposed on an opposite side of the first conductor in the first active material layer and a second part penetrating between the first negative-electrode active material particles of the first active material layer from the first part.

In one embodiment, a length of a surface of a first layer on a first conductor side is greater than a length of a surface on the opposite side of the first conductor of the first layer in a cross-sectional image along a first direction in which the first active material layer and the first conductor are aligned.

In one embodiment, the second part of the first layer extends from the first part to a position beyond half of a particle diameter of at least one first negative-electrode active material particle exposed on the opposite side of the first conductor in a first direction where the first active material layer and the first conductor are aligned.

In one embodiment, the second part of the first layer extends from the first part to a position covering a portion closest to the first conductor of at least one first negative-electrode active material particle exposed on the opposite side of the first conductor in a first direction where the first active material layer and the first conductor are aligned.

In one embodiment, when an average thickness of the second part of the first layer in a cross-sectional image along a first direction where the first active material layer and the first conductor are aligned is denoted by Hav and an average particle diameter of the plurality of first negative-electrode active material particles included in the first active material layer is denoted by Rav, 0.3≤Hav/Rav≤3.0 is satisfied.

In one embodiment, 0.3≤Hav/Rav≤3.0 is satisfied in a plurality of cross-sectional images.

In one embodiment, 0.5≤Hav/Rav≤2.0 is satisfied.

In one embodiment, the inorganic material is an inorganic compound.

In one embodiment, the inorganic compound includes aluminum oxide.

In one embodiment, the first layer further includes an organic compound.

In one embodiment, the organic compound includes a fluorine-containing polymer compound.

In one embodiment, the polymer compound is polyvinylidene fluoride.

In one embodiment, a mass ratio of the inorganic material to the organic compound is 1:1 to 100:1.

In one embodiment, the negative-electrode active material particles of the first active material layer contain at least one of carbon materials, metals, metal oxides, semi-metals, and semi-metal oxides.

In one embodiment, the negative electrode further includes
a second active material layer provided on the second surface of the first conductor and containing a plurality of second negative-electrode active material particles; and
a second layer containing an inorganic material and including a third part provided across two or more second negative-electrode active material particles exposed on the opposite side of the first conductor in the second active material layer and a fourth part penetrating between the second negative-electrode active material particles of the second active material layer from the third part.

In one embodiment, the third part of the second layer extends from the fourth part to a position beyond half of a particle diameter of at least one second negative-electrode active material particle exposed on the opposite side of the first conductor in a second direction where the second active material layer and the first conductor are aligned.

In one embodiment, the fourth part of the second layer extends from the third part to a position covering the portion closest to the first conductor of at least one second negative-electrode active material particle exposed on the opposite side of the first conductor in a second direction where the second active material layer and the first conductor are aligned.

In one embodiment, a thickness, in a first direction in which the first active material layer and the first conductor are aligned, of the first part of the first layer, and a thickness, in a second direction in which the second active material layer and the first conductor are aligned, of the third part of the second layer, are different from each other.

In one embodiment, a thickness, in a first direction in which the first active material layer and the first conductor are aligned, of the first part of the first layer is greater than a thickness, in a second direction in which the second active material layer and the first conductor are aligned, of the third part of the second layer.

In one embodiment, the power storage element further includes a positive electrode and a separator arranged between the negative electrode and the positive electrode.

In one embodiment, the power storage element further includes a positive electrode; and a separator arranged between the negative electrode and the positive electrode, wherein a laminate having the negative electrode, the separator, and the positive electrode is wound.

In one embodiment, the laminate is wound so that the second layer is inside the first layer.

In one embodiment, a thickness of the second layer is less than a thickness of the first layer.

In one embodiment, the laminate is wound so that flattened portions and curved portions are alternately provided, and wherein a thickness of the first layer of the curved portion is less than a thickness of the first layer of the flattened portion.

According to some embodiments of the present disclosure, a power storage element such as a lithium-ion secondary battery with excellent cycle characteristics when used at high temperatures is provided.

### BRIEF DESCRIPTION OF DRAWINGS

FIG. 1 is a perspective view of a lithium-ion secondary battery 100 according to an embodiment.

FIG. 2 is a cross-sectional view of a laminate 90 according to an embodiment.

FIG. 3 is an enlarged cross-sectional view of a laminate 90 according to an embodiment.

FIG. 4A is an enlarged cross-sectional view of a negative electrode according to an embodiment.

FIG. 4B is an enlarged cross-sectional view of a negative electrode according to another embodiment.

FIG. 5 is an enlarged cross-sectional view of a negative electrode according to another embodiment.

FIG. 6 is an enlarged cross-sectional view of a negative electrode according to another embodiment.

FIG. 7 is an enlarged cross-sectional view of a negative electrode according to another embodiment.

FIG. 8 is an enlarged cross-sectional view of a negative electrode according to another embodiment.

FIG. 9 is an enlarged cross-sectional view of a laminate according to another embodiment.

FIG. 10 is an enlarged cross-sectional view of a laminate according to another embodiment.

FIG. 11 is an enlarged cross-sectional view of a curved portion of a laminate according to another embodiment.

FIG. 12 is a cross-sectional view of a lithium-ion secondary battery according to another embodiment.

FIG. 13 is a cross-sectional view of a lithium-ion secondary battery according to another embodiment.

### DESCRIPTION OF EMBODIMENTS

Hereinafter, technical solutions in the embodiments of the present disclosure will be described clearly and, in detail, but it is obvious that the described embodiments are only some of the embodiments of the present disclosure, not all of them. Unless otherwise defined, all technical and scientific terms used herein have the same meaning as commonly understood by those skilled in the art to which the present application pertains. The terminology used herein is for the purpose of describing particular embodiments only and is not intended to be limiting.

Hereinafter, an example of the present disclosure will be described. However, it should be understood that the present disclosure may be embodied in many different forms and should not be construed as being limited to the exemplary embodiments described herein.

In addition, in the accompanying drawings, dimensions or thicknesses of various components and layers may be exaggerated for simplicity and clarity. In the text, the same reference numerals refer to the same elements. As used herein, the term “and/or” includes any and all possible combinations of one or more of the associated listed items.

Furthermore, when an element A is referred to as being “connected to” an element B, it should be understood that element A may be directly connected to element B, or that an intermediate element C may be present such that element A is indirectly connected to element B.

The terminology used herein is intended for the purpose of describing specific embodiments only and is not intended to limit the scope of the present application.

As used herein, the singular forms are intended to include the plural forms as well, unless the context clearly indicates otherwise.

As used herein, the term “comprising, including, or containing” indicates the presence of the stated features, values, steps, operations, elements, and/or components, but does not preclude the presence or addition of one or more other features, values, steps, operations, elements, components, and/or combinations thereof.

A spatially relative term such as “on” may be used herein for ease of description to describe the relationship of one element or feature to another element(s) or feature(s) as illustrated in the drawings. It should be understood that spatially relative terms are intended to encompass different orientations of the device or apparatus in use or operation in addition to the orientation depicted in the drawings. For example, if the device in the drawings is turned upside down, elements described as being “above” or “on” other elements or features would then be oriented as “below” or “under.” Thus, the exemplary term “on” can encompass both upward and downward orientations.

Terms such as first, second, and third may be used herein to describe various elements, components, regions, layers, and/or portions, but such elements, components, regions, layers, and/or portions should not be limited by these terms. These terms are used merely to distinguish one element, component, region, layer, or portion from another. Thus, a first element, component, region, layer, or portion described below could be termed a second element, component, region, layer, or portion without departing from the teachings of the exemplary embodiments.

### (Power Storage Element)

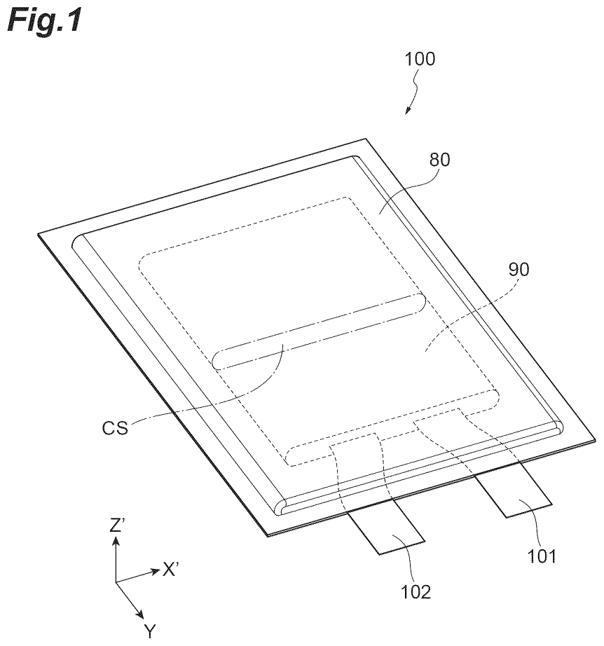

FIG. 1 is a perspective view of a power storage element according to an embodiment of the present disclosure. The power storage element 100 includes a case 80 and a laminate 90 accommodated within the case 80. Leads 101 and 102 are connected to the laminate 90 and are drawn out from the interior to the exterior of the case 80. The material of the case 80 is not particularly limited, and may be, for example, a resin sheet, a resin-coated metal sheet, or the like.

Herein, an axial direction of winding of the laminate 90 is referred to as a Y-direction, a thickness direction of the laminate 90 (a direction perpendicular to the Y-direction and in which a thickness of the laminate 90 is smallest) is referred to as a Z′ direction (first direction), and a direction perpendicular to both the Y-direction and the Z′ direction is referred to as an X′ direction.

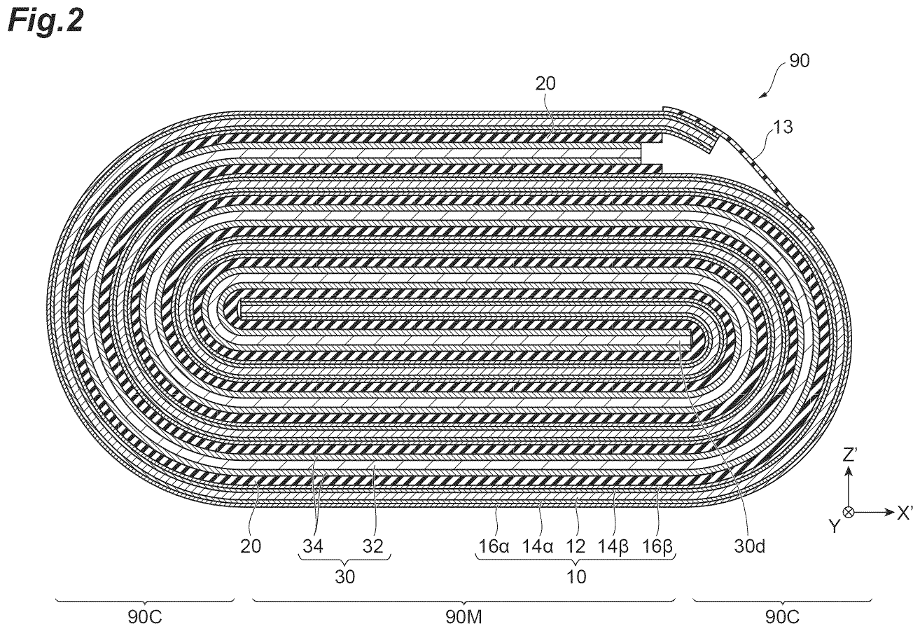

FIG. 2 is a cross-sectional view taken along an X′Z′ plane, which is perpendicular to a Y-axis of the laminate 90 according to an embodiment of the present disclosure, and is an enlarged view of a cross-section CS of the laminate 90 of FIG. 1. The laminate 90 includes a negative electrode 10, a positive electrode 30, and a separator 20, and the negative electrode 10, the positive electrode 30, and the separator 20 are wound in a state in which the separator 20 is interposed between the negative electrode 10 and the positive electrode 30. An end portion of the winding of the laminate 90 is fixed with a tape 13. The negative electrode 10, the positive electrode 30, and the separator 20 are each in the form of a sheet. The laminate 90 has a flattened portion 90M in which a laminate of the positive electrode 30, the separator 20, and the negative electrode 10 is arranged flat, and curved portions 90C which are arranged at both ends of the flattened portion 90M and in which a laminate of the positive electrode 30, the separator 20, and the negative electrode 10 is curved. The laminate 90 is wound so that the flattened portion 90M and the curved portions 90C are alternately provided. The positive electrode 30 includes a second conductor 32 and a positive-electrode active material layer 34, while the negative electrode 10 primarily includes a first conductor 12 and a first active material layer 14.

### (Negative Electrode 10)

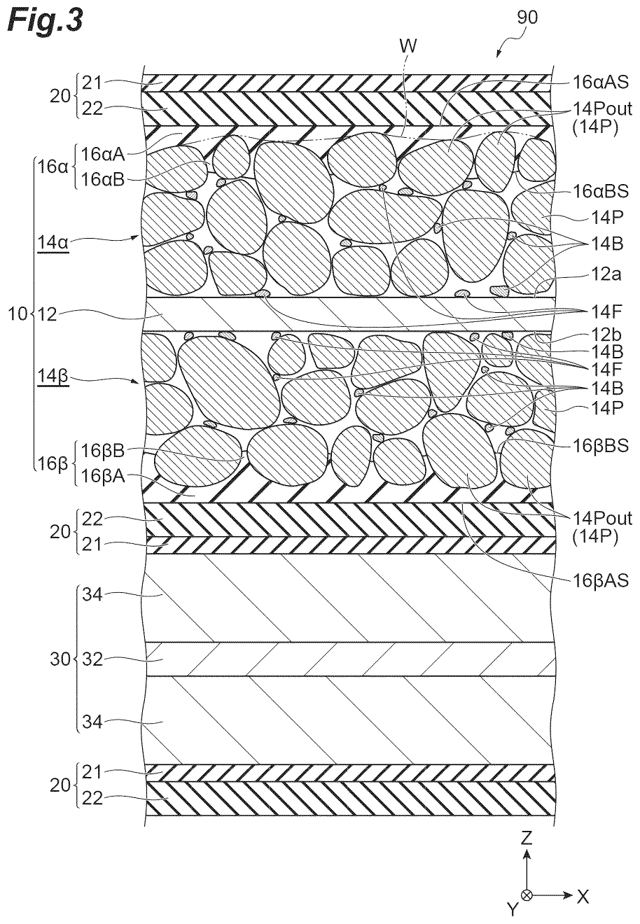

FIG. 3 shows an example of an enlarged cross-sectional view of the flattened portion 90M of the laminate 90 of FIG. 2. The negative electrode 10 includes a first conductor 12, a first active material layer 14α provided on a first surface 12a of the first conductor 12, a first layer 16α disposed so as to sandwich the first active material layer 14α together with the first conductor 12, a second active material layer 14β provided on a second surface 12b of the first conductor 12, and a second layer 16β sandwiching the second active material layer 14β together with the first conductor 12. A main surface of the first layer 16α of the negative electrode 10 is in contact with a main surface of the separator 20. A main surface of the second layer 16β of the negative electrode 10 is also in contact with a main surface of the separator 20.

In FIGS. 3 to 10, the Y-direction is a direction parallel to a winding axis of the laminate 90, as in FIGS. 1 and 2.

In FIGS. 3 to 10, the Z-direction is a direction (first direction) in which the first active material layer 14a and the first conductor 12 are arranged, and can also be referred to as a direction perpendicular to the first surface 12a of the first conductor 12. Moreover, the Z-direction is a direction (second direction) in which the second active material layer 14β and the first conductor 12 are arranged, and can be referred to as a direction perpendicular to the second surface 12b of the first conductor 12.

In FIGS. 3 to 10, the X-direction is a direction perpendicular to both the Y-direction and the Z-direction.

Herein, unless defined otherwise, “cross-section” refers to a cross-section along the Z-direction.

In FIGS. 3 to 10, a vertical direction is the Z-direction, and a horizontal direction is the X-direction.

### (First Conductor 12)

An example of the first conductor 12 is a thin metal sheet (metal foil) of copper, nickel, stainless steel, or an alloy thereof, which is a conductive plate material. The thickness of the first conductor 12 can be, for example, 5 to 20 μm.

### (First Active Material Layer 14α and Second Active Material Layer 14β)

The first active material layer 14a includes a plurality of negative-electrode active material particles (first negative-electrode active material particles) 14P, and the second active material layer 14β includes a plurality of negative-electrode active material particles (second negative-electrode active material particles) 14P. The negative-electrode active material may be any material capable of absorbing and releasing (intercalating/de-intercalating or doping/de-doping) lithium ions. Examples of negative-electrode active material particles 14P include at least one selected from carbon materials, metals, metal oxides, semimetals, and semimetal oxides. The negative-electrode active material particles (first negative-electrode active material particles) 14P of the first active material layer 14α and the negative-electrode active material particles (second negative-electrode active material particles) 14P of the second active material layer 14β may be the same or different.

Examples of the carbon materials used for the negative-electrode active material particles 14P include graphite, hard carbon, soft carbon, and low-temperature fired carbon.

Examples of the metals used for the negative-electrode active material particles 14P are metals such as Al and Sn that are capable of forming compounds with lithium.

An example of a semi-metal used in the negative-electrode active material particles 14P is Si.

Examples of metal oxides used in the negative-electrode active material particles 14P are TiO₂, SnO₂, and lithium titanate (Li₄Ti₅O₁₂).

An example of a semimetal oxide used for the negative-electrode active material particles 14P is SiOₓ(0<x<2).

In the first active material layer 14α and the second active material layer 14β in FIG. 3, the arrangement of the negative-electrode active material particles 14P may be random.

The particle diameter of the negative-electrode active material particles 14P may be 2 to 20 μm in D50 of the number-based distribution of area-equivalent circle diameters in cross-sectional images of the first active material layer 14α and the second active material layer 14β.

### (Organic Compound)

The first active material layer 14α and the second active material layer 14β may contain organic compounds 14B such as polymers. The organic compound can bond the negative-electrode active material particles 14P to each other and/or bond the negative-electrode active material particles 14P and the first conductor 12. In FIGS. 3, 6, and 9 to 11, portions hatched from the upper left to the lower right with the narrowest spacing correspond to the organic compound 14B.

Examples of the organic compound 14B include fluororesins such as polyvinylidene fluoride (PVDF) and polytetrafluoroethylene (PTFE). Other examples of organic compounds include cellulose, styrene-butadiene rubber, ethylene-propylene rubber, acrylic resins, polyimide resins, polyamide-imide resins, and the like.

Moreover, the organic compound may be an electronically conductive polymer or an ionically conductive polymer. Examples of electronically conductive polymers include polyacetylene and the like. In this case, because the organic compound also functions as a conductive auxiliary agent particle, it is not necessary to add a conductive auxiliary agent. As the ionically conductive polymer, one having ionic conductivity such as lithium-ion conductivity may be used and, for example, composites formed of a monomer of a polymer compound (such as a polyether-based polymer compound of polyethylene oxide, polypropylene oxide, and the like, polyphosphazene, or the like) and a lithium salt such as LiClO₄, LiBF₄, LiPF₆, or an alkali metal salt mainly containing lithium are included. Examples of polymerization initiators used for such composite formation include photopolymerization initiators or thermal polymerization initiators suitable for the above monomer.

When added, the addition amount of the organic compound may be 2 to 20 mass % relative to the mass of the negative-electrode active material particles.

### (Negative-Electrode Conductive Auxiliary Agent)

The first active material layer 14α and the second active material layer 14β may further contain a negative-electrode conductive auxiliary agent 14F. As the negative-electrode conductive auxiliary agent, publicly known conductive auxiliary agents can be used. For example, the negative-electrode conductive auxiliary agent includes carbon-based materials such as graphite, carbon black, and acetylene black; metal fine powders such as copper, nickel, stainless steel, and iron; mixtures of carbon materials and metal fine powders; and conductive oxides such as ITO. The addition amount of the negative-electrode conductive auxiliary agent may be 0.5 to 5 mass % relative to the mass of the negative-electrode active material particles. In addition, in FIGS. 3, 6, and 9 to 11, the regions having the narrowest hatching extending from the upper right to the lower left correspond to the negative-electrode conductive auxiliary agent 14F.

### (Thicknesses of First Active Material Layer 14α and Second Active Material Layer 14β)

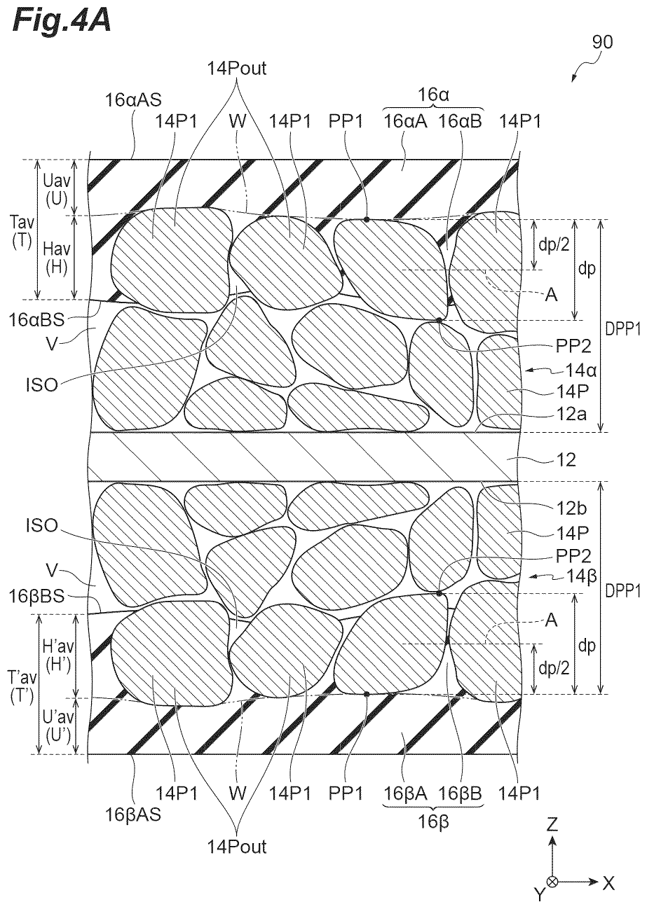

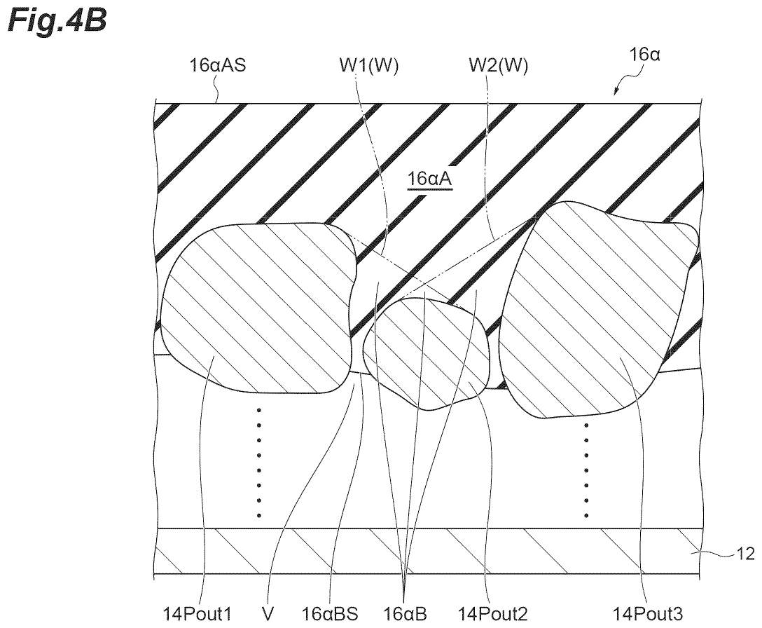

The thicknesses of the first active material layer 14α and the second active material layer 14β may be 5 to 300 μm, and may be the same as each other or different from each other. FIG. 4A shows an example of an enlarged cross-sectional view of the negative electrode 10 in the flattened portion 90M of the laminate 90 of FIG. 2. The thickness of the first active material layer 14α is defined, in a cross-sectional image along the Z-direction of the negative electrode illustrated in FIG. 4A, as an arithmetic mean of distances DPP1 from a point PP1 farthest from the first conductor 12 in the Z-direction among the negative-electrode active material particles 14Pout exposed on the opposite side of the first conductor 12 included in the first active material layer 14α to the first conductor 12, calculated for all negative-electrode active material particles 14Pout exposed on the opposite side of the first conductor 12 included in the first active material layer 14α in the cross-sectional image.

The thickness of the second active material layer 14β is defined, in a cross-sectional image along the Z-direction of the negative electrode as illustrated in FIGS. 4A and 4B, as an arithmetic mean of the distances DPP1 from the point PP1 farthest from the first conductor 12 in the Z-direction among the negative-electrode active material particles 14Pout exposed on the opposite side of the first conductor 12 included in the second active material layer 14β, to the first conductor 12, calculated for all negative-electrode active material particles 14Pout exposed on the opposite side of the first conductor 12 included in the second active material layer 14β in the cross-sectional image.

The magnification of the cross-sectional image can be set so that the number of negative-electrode active material particles 14Pout exposed on the opposite side of the first conductor 12 in each active material layer is about 5 to 100.

### (First Layer 16α and Second Layer 16β)

The first layer 16a has a first part 16αA provided across two or more negative-electrode active material particles 14Pout (first negative-electrode active material particles) exposed on the opposite side of the first conductor 12 in the first active material layer 14α, and a second part 16αB penetrating between adjacent negative-electrode active material particles (first negative-electrode active material particles) 14P of the first active material layer 14α from the first part 16αA.

The second layer 16β has a third part 16βA provided across two or more negative-electrode active material particles 14Pout (second negative-electrode active material particles) exposed on the opposite side of the first conductor 12 in the second active material layer 14β, and a fourth part 16βB penetrating between adjacent negative-electrode active material particles (second negative-electrode active material particles) 14P of the second active material layer 14β from the third part 16βA.

Herein, the phrase “between negative-electrode active material particles (first negative-electrode active material particles) 14P where the second part 16αB is arranged” refers to a set of areas V sandwiched between any two negative-electrode active material particles 14P (first negative-electrode active material particles), which may be adjacent in any direction in the first active material layer 14α. The second part 16αB can extend until it comes into contact with the first conductor 12.

The first part 16αA is an area of the first layer 16α that is separated from the above set of areas V.

The phrase “between negative-electrode active material particles (second negative-electrode active material particles) 14P where the fourth part 16βB is arranged” refers to a set of areas V sandwiched between any two negative-electrode active material particles 14P (second negative-electrode active material particles) adjacent in any direction in the second active material layer 14β.

The third part 16βA is an area of the second layer 16β that is separated from the above set of areas V.

A boundary between the first part 16αA and the second part 16αB is formed, in the above-described cross-section, by a common external tangent W of the negative-electrode active material particles 14Pout exposed on the opposite side of the first conductor 12 and adjacent in the direction perpendicular to the Z-direction (e.g., the X-direction in FIGS. 3 and 4A). A boundary between the third part 16βA and the fourth part 16βB is formed by a common external tangent W of the negative-electrode active material particles 14Pout exposed on the opposite side of the first conductor 12 and adjacent in the direction perpendicular to the Z-direction (e.g., the X-direction in FIGS. 3 and 4A).

As shown in FIG. 4B, for example, in the above-described cross-section, when a common external tangent W1 between a negative-electrode active material particle 14Pout1 and a negative-electrode active material particle 14Pout2 that are adjacent in the direction perpendicular to the Z-direction and a common external tangent W2 between the negative-electrode active material particle 14Pout2 and a negative-electrode active material particle 14Pout3 that are adjacent in the direction perpendicular to the Z-direction intersect, the side closer to the first conductor 12 than each common external tangent W is defined as the second part 16αB rather than the first part 16αA. Accordingly, in FIG. 4B, the boundary between the first part 16αA and the second part 16αB of the first layer 16a has a shape (a V-shape in the drawing) formed by the parts of the common external tangents W1 and W2 that are farthest from the first conductor 12.

Although not shown, in the above-described cross-section, when the common external tangents intersect with each other at the boundary between the third part 16βA and the fourth part 16βB, the side closer to the first conductor 12 than each common external tangent is defined as the fourth part 16βB rather than the third part 16βA, as described above.

### (Thickness U and Average Thickness Uav of First Part 16αA and Thickness U′ and Average Thickness U′Av of Third Part 16βA)

The thickness U of the first part 16αA is the distance of the first part 16αA along the Z-direction. The thickness U′ of the third part 16βA is the distance of the third part 16βA along the Z-direction.

An average thickness Uav of the first part 16αA and an average thickness U′av of the third part 16βA may be 0.1 to 5.0 μm. Uav and U′av may be 0.5 μm or more, 0.7 μm or more, or 1.0 μm or more. Uav and U′av may be 4.0 μm or less, or 3.0 μm or less.

The average thickness Uav of the first part 16αA is defined, in a cross-sectional image of the negative electrode along the Z-direction, as a value obtained by dividing an area of the first part 16αA, which is extracted by image processing from the first layer 16α and does not penetrate between the negative-electrode active material particles 14P of the first active material layer 14α, by a length of the first part 16αA in the direction perpendicular to the Z-direction in the image (for example, which is the X-direction in FIG. 3, but may be the Y-direction according to the cross-section). The magnification of the cross-sectional image can be set so that the length of the first part 16αA in the direction perpendicular to the Z-direction is, for example, 50 to 500 μm.

The average thickness U′av of the third part 16βA is defined, in a cross-sectional image of the negative electrode along the Z-direction, as a value obtained by dividing an area of the third part 16βA, which is extracted by image processing from the second layer 16β and does not penetrate between the negative-electrode active material particles 14P of the second active material layer 14β, by a length of the third part 16βA in the direction perpendicular to the Z-direction in the image. The magnification of the cross-sectional image can be set so that the length of the third part 16βA in the direction perpendicular to the Z-direction is, for example, 50 to 500 μm.

(Thickness H and Average Thickness Hav of Second Part 16αB, and Average Particle Diameter Rav of Negative-Electrode Active Material Particles Included in First Active Material Layer 14α, Thickness H′ and Average Thickness H′Av of Fourth Part 16βB, and Average Particle Diameter R′Av of Negative-Electrode Active Material Particles Included in Second Active Material Layer 14β)

A thickness H of the second part 16αB is the distance of the second part 16αB along the Z-direction. A thickness H′ of the fourth part 16βB is the distance of the fourth part 16βB along the Z-direction.

An average thickness Hav of the second part 16αB is defined, in a cross-sectional image of one negative electrode, as a value obtained by dividing an area of the second part 16αB penetrating between the negative-electrode active material particles 14P of the first active material layer 14α, extracted by image processing from the first layer 16a, by a length of the second part 16αB in the X-direction. The magnification of the cross-sectional image can be set so that the X-direction length of the second part 16αB is, for example, 50 to 500 μm.

An average thickness H′av of the fourth part 16βB is defined, in a cross-sectional image of one negative electrode, as a value obtained by dividing an area of the fourth part 16βB penetrating between the negative-electrode active material particles 14P of the second active material layer 14β, extracted by image processing from the second layer 16β, by a length of the fourth part 16βB in the X-direction. The magnification of the cross-sectional image can be set so that the X-direction length of the fourth part 16βB is, for example, 50 to 500 μm.

In another embodiment of the present disclosure, as shown in FIG. 4A, when the average thickness of the second part 16αB in one cross-sectional image along the first direction (Z-direction) is denoted by Hav and the average particle diameter of the plurality of negative-electrode active material particles 14P included in the first active material layer 14α in the image is denoted by Rav, 0.3≤Hav/Rav≤3.0 is satisfied.

In another embodiment of the present disclosure, when the average thickness of the fourth part 16βB in one cross-sectional image along the second direction (Z-direction) is denoted by H′av and the average particle diameter of the plurality of negative-electrode active material particles 14P included in the second active material layer 14β in the image is denoted by R′av, 0.3≤H′av/R′av≤3.0 is satisfied.

Rav denotes a particle diameter obtained by the number-based D50 of the area-equivalent circle diameter of all negative-electrode active material particles included in the first active material layer 14α in one cross-sectional image. R′av denotes a particle diameter obtained by the number-based D50 of the area-equivalent diameter of all negative-electrode active material particles included in the second active material layer 14β in one cross-sectional image. The number of active material particles to be measured in one cross-sectional image can be 10 to 1000.

In other embodiments of the present disclosure, from the viewpoint of improving cycle characteristics, 0.5≤Hav/Rav≤2.0 can also be satisfied, Hav/Rav≤1.5 can also be satisfied, Hav/Rav≤1.3 can also be satisfied, 0.5≤H′av/R′av≤2.0 can also be satisfied, H′av/R′av≤1.5 can also be satisfied, and H′av/R′av≤1.3 can also be satisfied.

At least one of Hav/Rav and H′av/R′av may be satisfied in one cross-sectional image or in a plurality of cross-sectional images. Specifically, at least one of Hav/Rav and H′av/R′av may be satisfied in two cross-sectional images, three cross-sectional images, or five cross-sectional images.

### (Thickness T and Average Thickness Tav of the First Layer 16α, and Thickness T′ and Average Thickness T′Av of the Second Layer 16β)

A thickness T of the first layer 16α is a distance of the first layer 16α along the Z-direction. A thickness T′ of the second layer 16β is a distance of the second layer 16β along the Z-direction.

Specifically, the thickness T of the first layer 16α is a distance from the surface 16αAS of the first layer 16α on the opposite side of the first conductor 12 in the Z-direction to the surface of the second part 16αB located on the first conductor 12 side in the Z-direction.

The thickness T′ of the second layer 16β is a distance from the surface 16βAS of the second layer 16β on the opposite side of the first conductor 12 in the Z-direction to the surface of the fourth part 16βB located on the first conductor 12 side in the Z-direction.

The average thickness Tav of the first layer 16α is defined as a value obtained by dividing the area of the first layer 16α extracted by image processing in a cross-sectional image of one negative electrode by the length of the first layer 16α in the first direction (X-direction). The magnification of the cross-sectional image can be set so that the length of the first layer 16a in the X-direction is, for example, 50 to 500 μm.

The average thickness T′av of the second layer 16β is defined as a value obtained by dividing an area of the second layer 16β extracted by image processing in a cross-sectional image of one negative electrode by a length of the second layer 16β in the second direction (X-direction). The magnification of the cross-sectional image can be set so that the length of the second layer 16β in the X-direction is, for example, 50 to 500 μm.

The average thickness Tav of the first layer 16α and the average thickness T′av of the second layer 16β are 0.1 to 300 μm.

Herein, Tav, Uav, Hav, and Hav/Rav, as well as T′av, U′av, H′av, and H′av/R′av, may be values obtained from a single cross-sectional image, but may alternatively be arithmetic averages of values obtained from a plurality of cross-sectional images, for example, three or five images or the like.

### (Relationship of Surface Roughnesses on Both Sides of the First Layer 16α, and Relationship of Surface Roughnesses on Both Sides of the Second Layer 16β)

In another embodiment of the present disclosure, in a cross-sectional image of the negative electrode along the Z-direction, a length LαBS of the surface 16αBS on the first conductor 12 side of the first layer 16a is greater than a length LαAS of the surface 16αAS on the opposite side of the first conductor 12 of the first layer 16α. LαBS/LαAS may be 1.1 or more, and may be 1.2 or more.

In another embodiment of the present disclosure, in a cross-sectional image of the negative electrode along the Z-direction, the length LβBS of the surface 16βBS on the first conductor 12 side of the second layer 16β is greater than the length LβAS of the surface 16βAS on the opposite side of the first conductor 12 of the second layer 16β. LβBS/LβAS may be 1.1 or more, and may be 1.2 or more.

Here, the surface 16αBS on the first conductor 12 side of the first layer 16α also includes a contact interface between the first layer 16α and the negative-electrode active material particles 14P. The surface 16βBS on the first conductor 12 side of the second layer 16β includes a contact interface between the second layer 16β and the negative-electrode active material particles 14P.

As shown in FIG. 4A, an isolated portion ISO of the second part 16αB of the first layer 16α, which is not connected to the first part 16αA, is excluded from the calculation of the length LαBS of the surface 16αBS. Likewise, an isolated portion ISO of the fourth part 16βB of the second layer 16β, which is not connected to the third part 16βA, is excluded from the calculation of the length LβBS of the surface 16βBS.

The magnification of the cross-sectional image used to obtain the length of each surface can be set so that the number of negative-electrode active material particles 14Pout exposed on the opposite side of the first conductor 12 in the cross-sectional image is about 5 to 100. After curves of both surfaces of each of the first and second layers based on a compositional difference between the first and second layers and the negative-electrode active material particles are extracted from SEM-EDX cross-sectional images, each surface length can be acquired based on the number of pixels and pixel size constituting each curve.

In an embodiment, in a cross-sectional image of the negative electrode along the Z-direction, the length LαAS of the surface 16αAS on the opposite side of the first conductor 12 of the first layer 16α may be less than 1.1, or less than 1.05, relative to the length of the first layer 16α in the direction (X-direction in FIG. 3) perpendicular to the Z-direction.

In an embodiment, in a cross-sectional image of the negative electrode along the Z-direction, the length LβAS of the surface 16βAS on the opposite side of the first conductor 12 of the second layer 16β may be less than 1.1, or less than 1.05, relative to the length of the second layer 16β in the direction (X-direction in FIG. 3) perpendicular to the Z-direction.

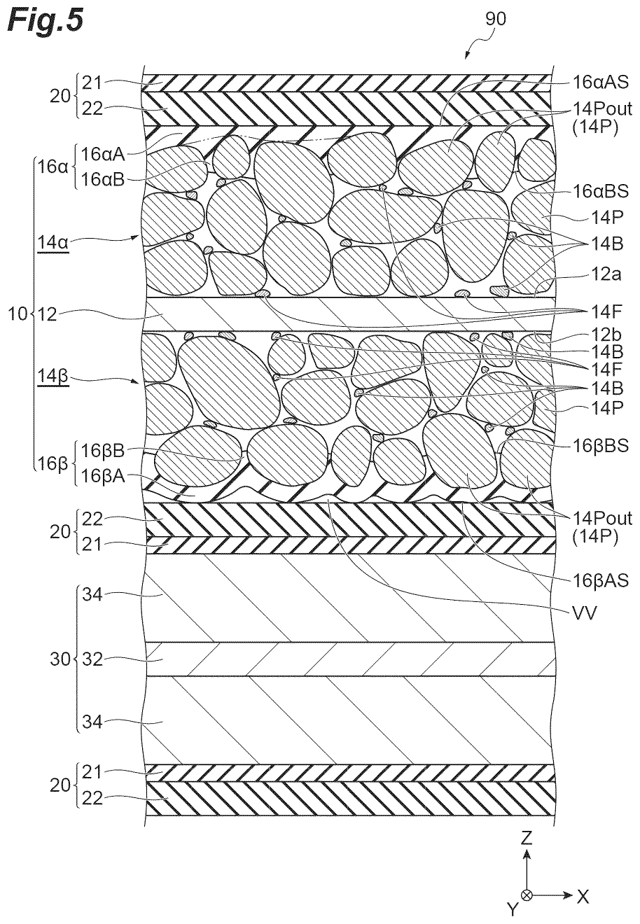

In an embodiment, as shown in FIG. 5, while the ratio of the length of the surface 16αAS of the first layer 16α to the length of the first layer 16α in the direction (X-direction in FIG. 3) perpendicular to the Z-direction is less than 1.1 or less than 1.05, the ratio of the length of the surface 16βAS of the second layer 16β to the length of the second layer 16β in the direction (X-direction in FIG. 3) perpendicular to the Z-direction may be 1.1 or more, or 1.2 or more. Moreover, in contrast, while the ratio of the length of the surface 16αAS of the first layer 16α to the length of the first layer 16α in the direction (X-direction in FIG. 3) perpendicular to the Z-direction is 1.1 or more, or 1.2 or more, the ratio of the length of the surface 16βAS of the second layer 16β to the length of the second layer 16β in the direction (X-direction in FIG. 3) perpendicular to the Z-direction may be less than 1.1 or less than 1.05.

In this case, a gap VV may be formed in a portion between the separator 20 and one of the surface 16αAS of the first layer 16a and the surface 16βAS of the second layer 16β that has the larger ratio to the above-mentioned length. The one of the surface 16αAS of the first layer 16a and the surface 16βAS of the second layer 16β that has the larger ratio to the above-mentioned length may be located on either the inner side or the outer side of the winding. The inner winding side refers to the side closer to the winding axis, and the outer winding side refers to the side farther from the winding axis.

### (Form of Second Part 16αB and Fourth Part 16βB)

In another embodiment of the present disclosure, as shown in the schematic view of the cross-sectional image of FIG. 4A, the second part 16αB of the first layer 16α includes a portion extending from the first part 16αA to a position beyond dp/2, which is half the length of the particle diameter dp of at least one negative-electrode active material particle 14P1 (first negative-electrode active material particle) exposed on the opposite side of the first conductor 12 in the Z-direction.

Here, the particle diameter dp of the negative-electrode active material particle refers to a distance along the first direction (Z-direction) between the point PP1 of the negative-electrode active material particle 14P1 farthest from the first conductor 12 and a point PP2 of the negative-electrode active material particle 14P closest to the first conductor 12 in the cross-sectional image of the negative electrode 10 along the first direction (Z-direction). Moreover, in the first active material layer 14α, the distance DPP1 in the first direction (Z-direction) between the first surface 12a of the first conductor 12 and the point PP1 of the negative-electrode active material particle 14P farthest from the first conductor 12 may be different for each negative-electrode active material particle 14P. In the second active material layer 14β, the distance DPP1 in the first direction (Z-direction) between the second surface 12b of the first conductor 12 and the point PP1 of the negative-electrode active material particle 14P farthest from the first conductor 12 may be different for each negative-electrode active material particle 14P.

The fact that the second part 16αB extends to a position beyond dp/2, which is half the length of the particle diameter dp, means that the second part 16αB exceeds, in the Z-direction, a line A that passes through a point that is half the particle diameter (dp/2) of the negative-electrode active material particle 14P1 and extends in the X-direction perpendicular to the Z-direction, on at least one side of the negative-electrode active material particle 14P1 in the X-direction. The second part 16αB extends from the first part 16αA across the line A in the Z-direction.

Likewise, the fourth part 16βB of the second layer 16β includes a portion extending from the third part 16βA to a position beyond dp/2, which is half the length of the particle diameter dp of at least one negative-electrode active material particle 14P1 (second negative-electrode active material particle) exposed on the opposite side of the first conductor 12 in the Z-direction.

The fact that the fourth part 16βB of the second layer 16β extends to a position beyond dp/2 that is half the length of the particle diameter dp means that the fourth part 16βB exceeds a line A that passes through a point that is half the particle diameter (dp/2) of the negative-electrode active material particle 14P1 in the Z-direction and extends in the X-direction perpendicular to the Z-direction, on at least one side of the negative-electrode active material particle P1 in the X-direction. The fourth part 16βB extends from the third part 16βA across the line A in the Z-direction.

In another embodiment of the present disclosure, the thicknesses and average thicknesses of the first conductor 12, the first active material layer 14α, the second active material layer 14β, the first layer 16α, the second layer 16β constituting the negative electrode 10, and the second conductor 32 and the positive-electrode active material layer 34 constituting the positive electrode 30 are the same in the flattened portion 90M and the curved portion 90C in FIG. 2.

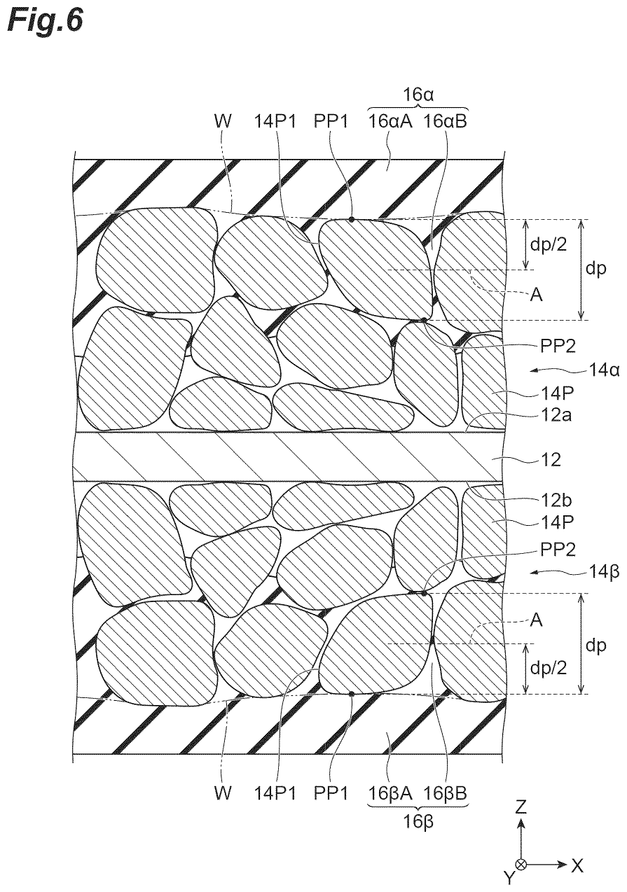

In another embodiment of the present disclosure, as shown in FIG. 6, the second part 16αB of the first layer 16α extends from the first part 16αA to a position covering the point PP2 of at least one negative-electrode active material particle 14P1 that is closest to the first conductor 12, exposed on the opposite side of the first conductor in the first direction (Z-direction), and extends beyond the point PP2 in the Z-direction.

In another embodiment of the present disclosure, as shown in FIG. 6, the fourth part 16βB of the second layer 16β extends from the third part 16βA to a position covering the point PP2 of at least one negative-electrode active material particle 14P2 that is closest to the first conductor 12, exposed on the opposite side of the first conductor in the second direction (Z-direction), and extends beyond the point PP2 in the Z-direction.

In the above embodiments described using FIGS. 2 to 6, as shown in FIG. 3 and the like, the first layer 16α is provided on the first active material layer 14α, and the second layer 16β is provided on the second active material layer 14β. However, in another embodiment of the present disclosure, even if the negative electrode 10 has a first active material layer 14α and a second active material layer 14β on both sides of the first conductor 12, it may have only one of the first layer 16α or the second layer 16β.

Although the negative electrode 10 has the first active material layer 14α and the second active material layer 14β on both sides of the first conductor 12 in the above embodiments illustrated using FIGS. 2 to 6, the negative electrode 10 only needs to include either the first layer 16α or the second layer 16β when the negative electrode 10 has only one of the first active material layer 14α and the second active material layer 14β.

The first layer 16α and the second layer 16β contain an inorganic material. An Example of the inorganic material is an inorganic compound. Examples of the inorganic compound include metal oxides and metal hydroxides. Examples of metal oxides are particulate forms of one or more selected from aluminum oxide, magnesia, titania, silica, zirconia, zinc oxide, iron oxide, ceria, yttria, and the like. An example of a metal hydroxide is magnesium hydroxide. Examples of aluminum oxide are alumina (Al₂O₃), alumite (Al₂O₃·3H₂O), boehmite (Al₂O₃·5H₂O). Preferred inorganic materials include alumina, boehmite, magnesia, and magnesium hydroxide. The inorganic material may be a plurality of particles. An average particle diameter defined by the D50 of a volume-based particle size distribution measured by laser diffraction of particles of an inorganic material may be 10 to 1000 nm.

The first layer 16α and the second layer 16β may further contain an organic compound. Examples of organic compounds are fluorine-containing polymer compounds, an example of which is polyvinylidene fluoride (PVdF). The organic compound can function as a binder that binds inorganic material particles together and binds inorganic material particles to negative-electrode active material particles.

The mass ratio of the inorganic compound and the organic compound in the first layer 16a and the second layer 16β may be 1:1 to 100:1.

### (Positive Electrode)

The positive electrode 30 has a plate-shaped second conductor 32 and a positive-electrode active material layer 34 on one or both sides of the second conductor 32.

### (Second Conductor)

The second conductor 32 may be, for example, a thin metal plate (metal foil) made of aluminum, copper, nickel, or an alloy thereof.

### (Positive-Electrode Active Material Layer)

The positive-electrode active material layer 34 may mainly include positive-electrode active material particles, a positive electrode binder, and, if necessary, a conductive auxiliary agent.

### (Positive-Electrode Active Material)

The positive-electrode active material is not particularly limited as long as it can reversibly undergo lithium-ion storage and release, lithium-ion desorption and insertion (intercalation), or lithium-ion doping and de-doping with a counter anion (e.g., ClO₄⁻), and known active materials may be used. Examples include lithium cobalt oxide (LiCoO₂), lithium nickel oxide (LiNiO₂), lithium manganese spinel (LiMn2O4), and composite metal oxides represented by the general formula: LiNiₓCo_{y}Mn_{z}MaO₂ (x+y+z+a=1, 0≤x≤1, 0≤y≤1, 0≤z≤1, 0≤a≤1, M is one or more elements selected from Al, Mg, Nb, Ti, Cu, Zn, and Cr), lithium vanadium compounds (LiV₂O₎, olivine-type LiMPO₄ (where M is one or more elements selected from Co, Ni, Mn, Fe, Mg, Nb, Ti, Al, and Zr, or VO), lithium titanate (Li₄Ti₅O₁₂), and composite metal oxides such as LiNiₓCo_{y}AlzO₂ (0.9<x+y+z<1.1).

### (Positive Electrode Binder)

The positive-electrode active material layer 34 may contain an organic compound. The organic compound can function as a binder that binds active materials together and binds the active material to the second conductor 32. The organic compound may be any compound capable of the above-mentioned binding, and examples thereof include fluororesins such as polyvinylidene fluoride (PVDF) and polytetrafluoroethylene (PTFE). Furthermore, in addition to the above, for example, cellulose, styrene-butadiene rubber, ethylene-propylene rubber, acrylic resin, polyimide resin, and polyamide-imide resin may be used as the binders.

The content of the organic compound in the positive-electrode active material layer 34 is not particularly limited, but when added, it is preferably 0.5 to 5 mass % relative to the mass of the active material.

### (Positive-Electrode Conductive Additive)

The positive-electrode active material layer 34 may include a conductive additive. The conductive additive is not particularly limited as long as it improves the conductivity of the positive-electrode active material layer 34, and the materials listed as negative-electrode conductive additives may be used.

The content of the conductive additive in the positive-electrode active material layer 34 is not particularly limited, but when added, it may be 0.5 to 5 mass % relative to the mass of the active material.

### (Separator 20)

The separator 20 is not particularly limited in terms of material. Examples of separators include a main layer 22, which is typically a porous sheet made of polyolefin such as polyethylene or polypropylene or a nonwoven fabric. A thickness of the main layer 22 may be 3.0 to 30 μm.

The separator 20 may have an inorganic compound-containing layer 21 on the side of the main layer 22 that contacts the positive-electrode active material layer 34. Examples of inorganic compounds in the inorganic compound-containing layer 21 are the same as those listed for the first layer 16α, for example, alumina particles. The inorganic compound-containing layer 21 may include an organic compound functioning as a binder. Examples of the organic compound are the same as those exemplified for the first layer 16α. The thickness of the main layer 22 may be 3.0 to 30 μm.

### (Laminated Form)

As shown in FIG. 2, the laminate 90 having a separator/positive electrode 30/separator/negative electrode 10 structure is wound so that the separator 20 is interposed between the positive electrode 30 and the negative electrode 10.

In each positive-electrode active material layer 34 of the positive electrode 30, one main surface is in contact with the second conductor 32, and the other main surface is in contact with the main surface of the separator 20. The main surface of the first active material layer 14α of the negative electrode 10 on the opposite side of the first layer 16α is in contact with the main surface of the first conductor 12. The surface of the first layer 16α of the negative electrode 10 on the opposite side of the first active material layer 14α is in contact with the main surface of the separator 20. The surface of the second active material layer 14β of the negative electrode 10 on the opposite side of the second layer 16β is in contact with the first conductor 12. The surface of the second layer 16β of the negative electrode 10 on the opposite side of the second active material layer 14β is in contact with the separator 20. For example, in the flattened portion 90M of the laminate 90, each layer is laminated in the Z-direction.

The lead 101 shown in FIG. 1 is connected to a portion of the second conductor 32 exposed from the positive-electrode active material layer 34. The lead 102 is connected to a portion of the first conductor 12 exposed from the first active material layer 14α or the second active material layer 14β. The leads 101 and 102 extend from the inside to the outside of the case 80.

As shown in FIG. 3, in another embodiment of the present disclosure, the first layer 16α of the negative electrode 10 is in contact with the main layer 22 of the separator 20. In an embodiment, the positive-electrode active material layer 34 of the positive electrode 30 is in contact with the inorganic compound-containing layer 21 of the separator 20.

### (Method of Fabricating First and Second Layers of Negative Electrode)

First, a laminate in which the first active material layer 14α and the second active material layer 14β are formed on both surfaces of the first conductor 12 is provided using a conventionally known method.

Next, inorganic particles, a binder, and a solvent are mixed to prepare a slurry for forming the first layer. Subsequently, the slurry for forming the first layer can be coated on at least one of the first active material layer 14α and the second active material layer 14β and then drying is performed under high temperature for a predetermined time.

In a case where the composition of the first layer is different from that of the second layer or the like, it is only necessary to coat the slurry for forming the second layer separately from the slurry for forming the first layer. In particular, the reduced-pressure drying process facilitates the penetration of the first layer 16α and/or the second layer 16β between the negative-electrode active material particles. Moreover, the longer the reduced-pressure drying time, the more easily the first layer 16α and/or the second layer 16β penetrate between the negative-electrode active material particles. Pressing the negative electrode after the formation of the first layer 16α and/or the second layer 16β facilitates the penetration of the first layer 16α and/or the second layer 16β between the negative-electrode active material particles.

### (Other Forms)

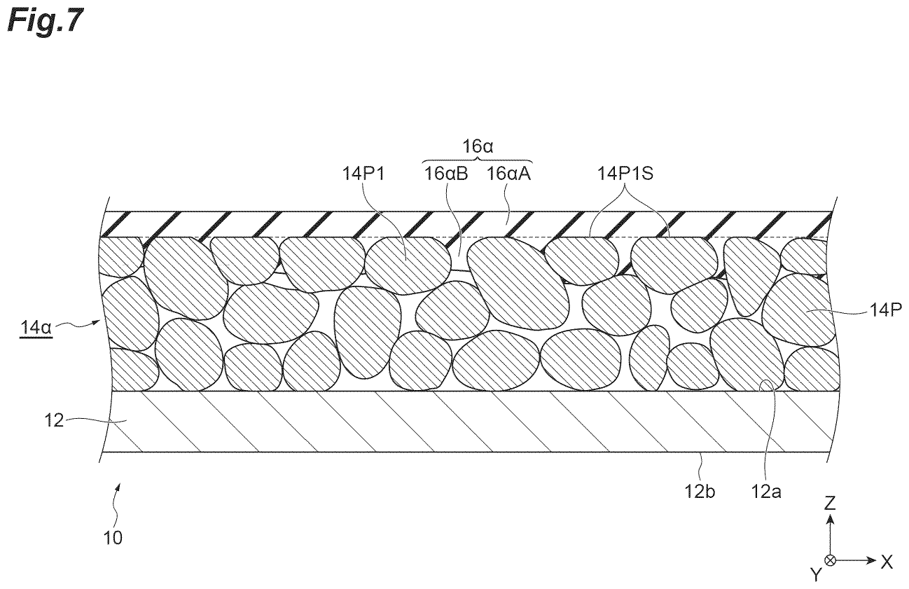

FIG. 7 is a cross-sectional view of a negative electrode 10 according to another embodiment. In this form, only the structure on the surface of one side of the first conductor 12 is illustrated, while the structure on the surface of the opposite side is omitted. In this form, in the first active material layer 14α, a part 14P1S of each surface of the negative-electrode active material particles 14P1, exposed on the opposite side of the first conductor 12, is flattened. Such a form can be easily obtained by pressing each surface of the negative-electrode active material particles 14P1 before the formation of the first layer 16. This form provides an effect of reducing the possibility of occurrence of negative-electrode active material particles 14P not being covered by the first layer 16α. If there are protrusions on the surface of a negative-electrode active material particle 14P1, such protrusions are likely to protrude from the first layer 16α. When there are uncovered portions of the negative-electrode active material particles, because an electric current tends to concentrate on a location of the first active material layer 14α where there is no the first layer 16α, due to a resistance value difference between the first layer 16α and the first active material layer 14α, the utilization of only those portions increases, leading to uneven degradation within the first active material layer 14α and, in some cases, deterioration of cycle characteristics.

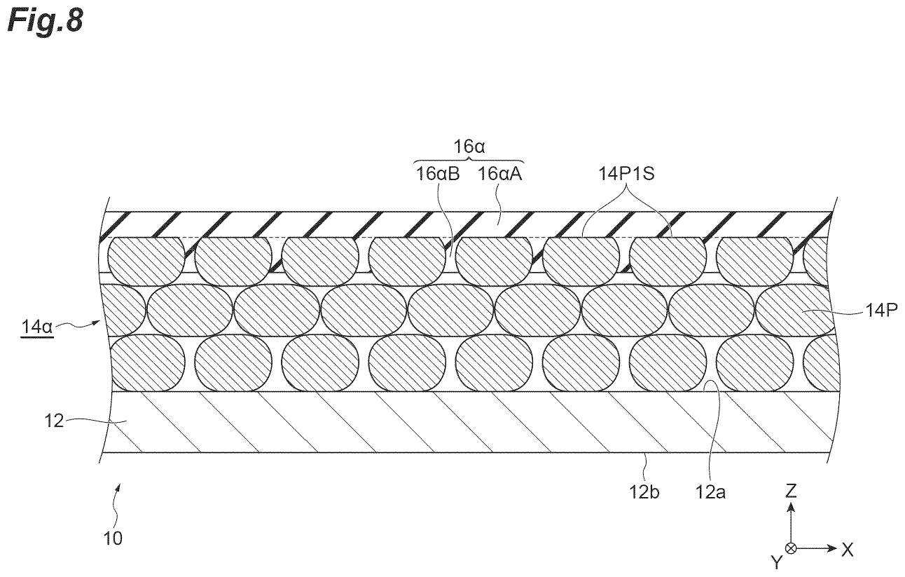

FIG. 8 is a cross-sectional view of a negative electrode according to another embodiment. In this form, in the first active material layer 14α, the negative-electrode active material particles 14P are aligned in the in-plane direction.

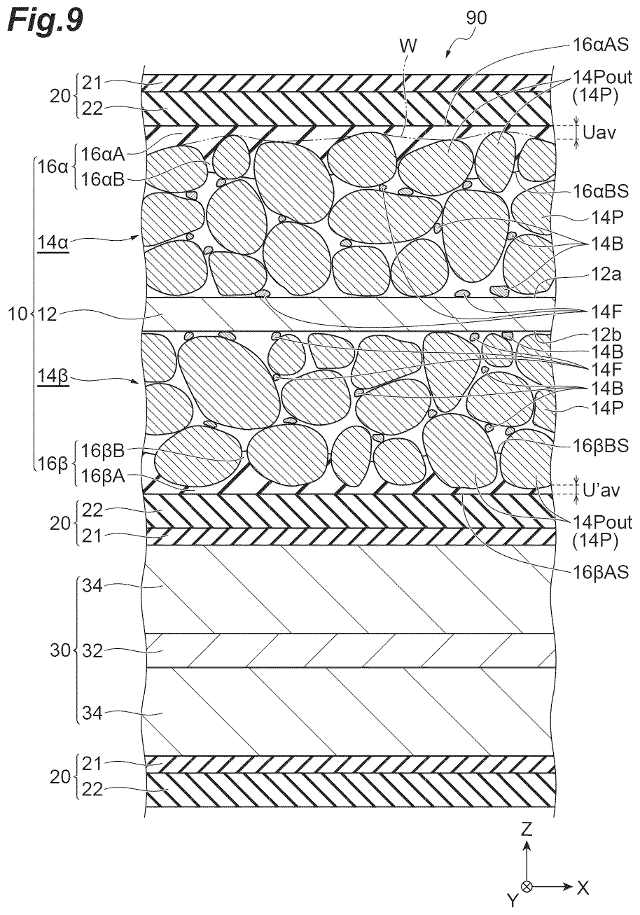

FIG. 9 is an enlarged view of the laminate 90 according to another embodiment. Although the average thickness Uav of the first part 16αA of the first layer 16α is the same as the average thickness U′av of the third part 16βA of the second layer 16β in FIG. 4A in the embodiment described above, the average thickness U′av of the third part 16βA of the second layer 16β is smaller than the average thickness Uav of the first part 16αA of the first layer 16α in the present embodiment. Within the first layer 16α and the second layer 16β, the average thickness U′av of the third part 16βA of the second layer 16β, located closer to the positive electrode 30, is less than the average thickness Uav of the first part 16αA of the first layer 16α, located farther from the positive electrode 30.

Although the negative electrode 10 may be wound so that the second layer 16β may be arranged on an outer winding side of the first layer 16α in the present embodiment, the negative electrode 10 may be wound so that the second layer 16β may be arranged on an inner winding side of the first layer 16α. The inner winding side is the side closer to the winding axis, and the outer winding side is the side farther from the winding axis. When the second layer 16β is wound on the inner winding side of the first layer 16α, the third part 16βA of the second layer 16β, which is located on the inner winding side where the radius of curvature becomes relatively small, can be made thinner, and, as adhesion to the opposing positive electrode is improved, high-temperature cycle characteristics are enhanced.

A difference between the average thickness Uav of the first part 16αA and the average thickness U′av of the third part 16βA may be 0 to 2.0 μm.

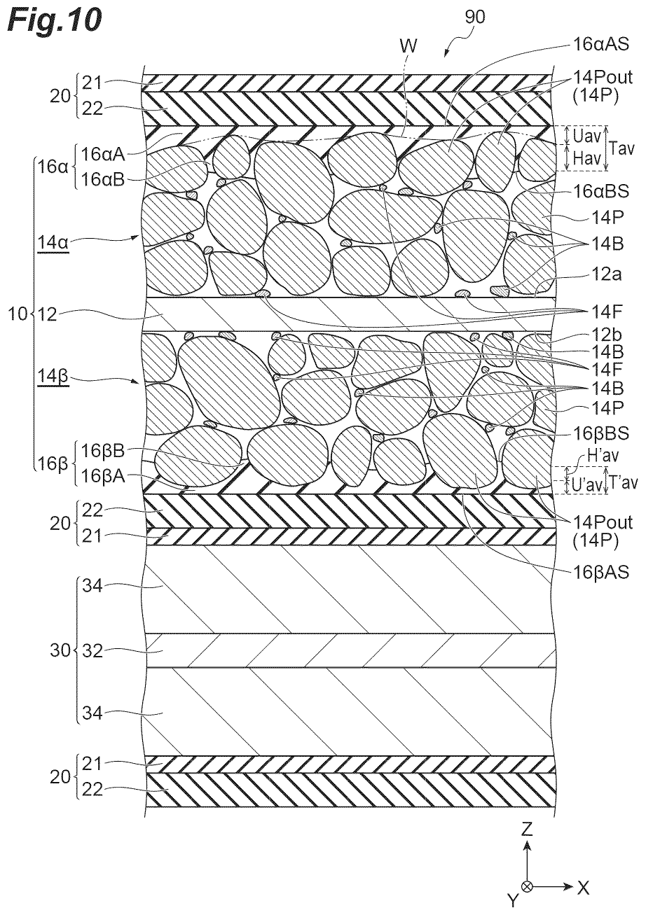

FIG. 10 is an enlarged view of the laminate 90 according to another embodiment. In the present embodiment, the average thickness T′av of the second layer 16β is smaller than the average thickness Tav of the first layer 16α located on the outer winding side.

The negative electrode 10 may be wound so that the second layer 16β is arranged on the outer winding side of the first layer 16α or the negative electrode 10 may be wound so that the second layer 16β is arranged on the inner winding side of the first layer 16α. The inner winding side is the side closer to the winding axis, and the outer winding side is the side farther from the winding axis. When the second layer 16β is wound on the inner winding side of the first layer 16α, the average thickness T′av of the second layer 16β on the inner winding side, where the radius of curvature becomes relatively small, can be made thinner, and, as adhesion to the opposing positive electrode is improved, high-temperature cycle characteristics are enhanced.

A difference between the average thickness Tav of the first layer 16α and the average thickness T′av of the second layer 16β may be 0 to 2.0 μm.

In this case, in an embodiment, the average thickness U′av of the third part 16βA is smaller than the average thickness Uav of the first part 16αA, and the average thickness H′av of the fourth part 16βB is smaller than the average thickness Hav of the second part 16αB. In an embodiment, the average thickness U′av of the third part 16βA is smaller than the average thickness Uav of the first part 16αA, while the average thickness H′av of the fourth part 16βB is equal to the average thickness Hav of the second part 16αB. In an embodiment, the average thickness U′av of the third part 16βA is equal to the average thickness Uav of the first part 16αA and the average thickness H′av of the fourth part 16βB is smaller than the average thickness Hav of the second part 16αB.

A difference between the average thickness Hav of the second part 16αB and the average thickness H′av of the fourth part 16βB may be 0 to 2.0 μm. A difference between the average thickness Uav of the first part 16αA and the average thickness U′av of the third part 16βA may be 0 to 4.0 μm.

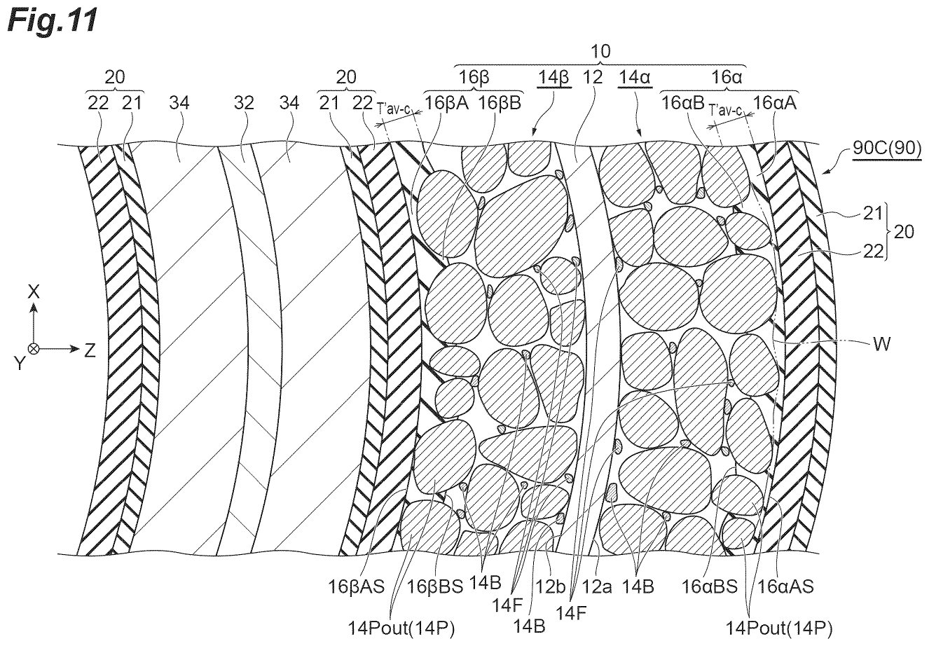

FIG. 11 is an enlarged cross-sectional view of a curved portion 90C of a laminate 90 according to another embodiment. Unlike FIGS. 3 to 10, the Z-direction, which is the first direction in which the first active material layer 14α and the first conductor 12 are aligned, corresponds to a radial direction of the curved portion 90C. The XYZ directions illustrated in FIG. 11 are the respective directions in the case where the radial direction of the central portion in the vertical direction of the laminate 90 shown in FIG. 11, i.e., the curved portion, is the horizontal direction.

In the embodiments described above with reference to FIGS. 2 to 8, there is no difference between the flattened portion 90M and the curved portion 90C of FIG. 2 in the average thickness Tav of the first layer 16α and, likewise in the average thickness T′av of the second layer 16β, of the negative electrode 10, as shown in FIG. 4A.

In contrast, in the present embodiment, an average thickness Tav-c of the first layer 16α at the curved portion 90C shown in FIG. 11 is smaller than the average thickness Tav of the first layer 16α at the flattened portion 90M shown in FIG. 3 (see FIG. 4A).

In another embodiment, the average thickness T′av-c of the second layer 16β at the curved portion 90C shown in FIG. 11 is smaller than the average thickness T′av of the second layer 16β at the flattened portion 90M shown in FIG. 3 (see FIG. 4A).

In another embodiment, the average thickness Tav-c of the first layer 16a at the curved portion 90C shown in FIG. 11 is smaller than the average thickness Tav of the first layer 16α at the flattened portion 90M, and the average thickness T′av-c of the second layer 16β at the curved portion 90C is also smaller than the average thickness T′av of the second layer 16β at the flattened portion 90M. In this case, adhesion with the opposing positive electrode is improved, thereby enhancing high-temperature cycle characteristics.

A difference between the average thicknesses Tav and Tav-c, and a difference between the average thicknesses T′av and T′av-c, may each be 0 to 2.0 μm.

In addition, the average thickness Tav-c of the first layer 16α and the average thickness T′av-c of the second layer 16β in the cross-sectional image of the curved portion are obtained by dividing the area of the first layer 16α by the length of the first layer 16α along the surface of the separator 20 on the first layer 16α side, and by dividing the area of the second layer 16β by the length of the second layer 16β along the surface of the separator 20 on the second layer 16β side, respectively.

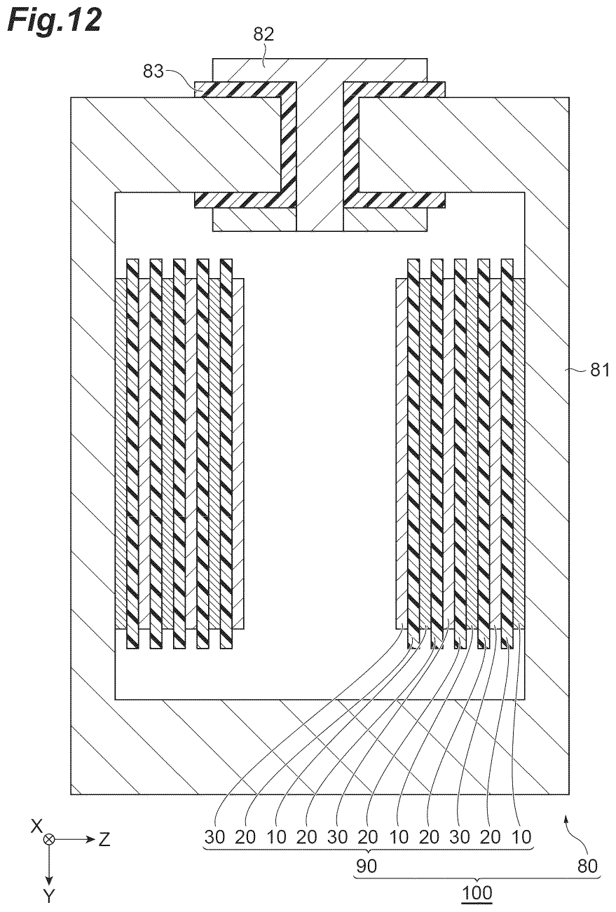

FIG. 12 is a cross-sectional view showing an example in which a laminate 90 including the negative electrode 10, the separator 20, and the positive electrode 30 is wound into a cylindrical shape and housed in the case 80. The case 80 includes a metal can 81, a gasket 83, and an electrode lead 82.

In FIG. 12, the winding axis corresponds to the Y-direction, the horizontal direction corresponds to the Z-direction in which the first active material layer 14α and the first conductor 12 are aligned, and the X-direction is a direction perpendicular to the Y- and Z-directions.

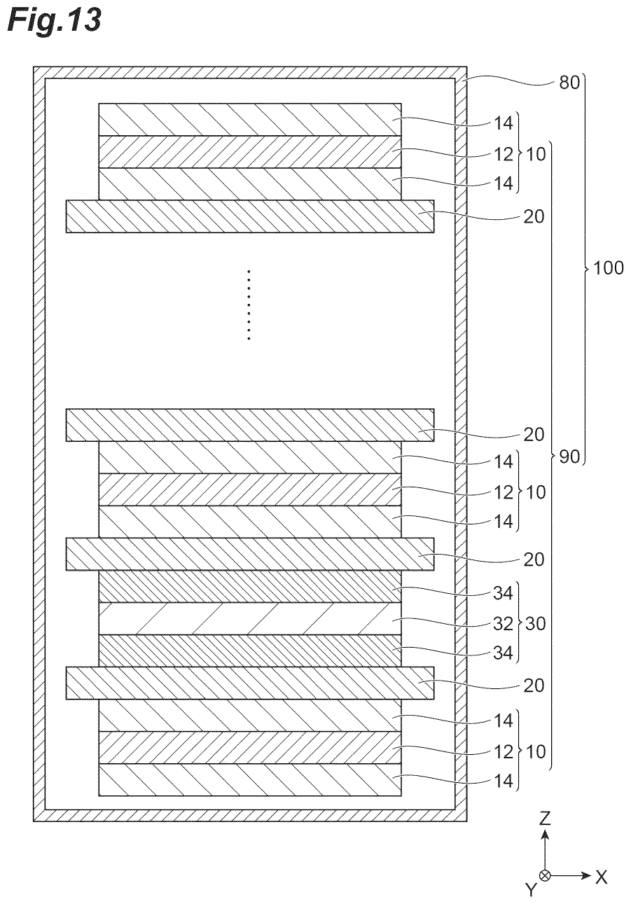

FIG. 13 shows a laminated-type power storage element in which a plurality of negative electrodes 10 and a plurality of positive electrodes 30 are laminated, with separators 20 interposed between the positive electrodes 30 and the negative electrodes 10. In FIG. 13, the Z-direction is the direction in which the first active material layer 14α and the first conductor 12 are aligned, while the X- and Y-directions are directions perpendicular to the Z-direction.

### (Operation)

The inventors have found that the cycle characteristics at high temperatures can be improved by allowing a part of the first layer 16α and the second layer 16β, which include inorganic compounds and are provided on the surfaces of the first active material layer 14α and the second active material layer 14β, to penetrate between the negative-electrode active material particles 14P of the first active material layer 14α and/or the second active material layer 14β as in the present embodiment.

By covering the gaps between negative-electrode active material particles with a part of the first layer 16α and the second layer 16β including inorganic materials, the surface roughness of the outer surface side of the negative electrode 10 is reduced, thereby lowering the interfacial resistance between the negative electrode 10 and the separator 20. Moreover, by filling the groove-like portions formed between the negative-electrode active material particles 14P, electric current concentration during charging is alleviated and the generation of dendrites can be suppressed, making it possible to perform stable cycles even at high temperatures.

### EXAMPLES

### (Method of Fabricating Lithium-Ion Secondary Batteries for Evaluation: Examples 1 to 22 and Comparative Example 1)

### Example 1: Example in which Only First Active Material Layer 14α has First Layer

### (Fabrication of Positive Electrode)

Positive-electrode active material particles, a conductive material, and a binder were mixed to fabricate a positive electrode mixture. The positive-electrode active material was lithium cobalt oxide (LiCoO₂; hereinafter abbreviated as LCO when referenced), the conductive material was carbon black, and the binder was polyvinylidene fluoride (PVDF). A mass ratio of the positive-electrode active material particles, conductive material, and binder was 96:2:2. This positive electrode mixture was dispersed in N-methyl-2-pyrrolidone (NMP) to fabricate a positive electrode slurry. Also, the positive electrode slurry was coated onto one surface of an aluminum foil having a thickness of 15 μm, used as the second conductor, such that the dry coating weight after drying was about 20.0 mg/cm². After coating, the positive electrode slurry was dried at 100° C. to remove the solvent, thereby forming a positive-electrode active material layer on one surface of the aluminum foil. After drying, the positive electrode slurry was applied onto the other surface of the aluminum foil so that the dry coating weight after drying was about 10.0 mg/cm 2. After coating, the positive electrode slurry was dried at 100° C. to remove the solvent to form the positive-electrode active material layer on both sides of the aluminum foil. After forming the positive-electrode active material layers on both surfaces of the second conductor, a pressing treatment was performed at 1000 kgf/cm to obtain the positive electrode.

### (Fabrication of Negative Electrode)

Negative-electrode active material particles, a conductive material, and a binder were mixed to fabricate a negative electrode mixture. The negative-electrode active material was graphite, and the binder was polyvinylidene fluoride (PVDF). A mass ratio of the negative-electrode active material particles and binder was 95:5. This negative electrode mixture was dispersed in N-methyl-2-pyrrolidone (NMP) to fabricate a negative electrode slurry. Also, the negative electrode slurry was coated onto one surface of a copper foil having a thickness of 10 μm, used as the first conductor, such that the dry coating weight after drying was about 6.0 mg/cm². After coating, the negative electrode slurry was dried at 100° C. to remove the solvent, thereby forming a first active material layer on one surface of the copper foil. After drying, the negative electrode slurry was coated on the other side of the copper foil so that the dry coating weight after drying was about 10.0 mg/cm². After coating, the negative electrode slurry was dried at 100° C. to remove the solvent, form the first active material layer on both sides of the copper foil, and form the first active material layer on both sides of the first conductor. The thickness of the first active material layer was about 50 μm.

### (Fabrication of First-Layer Slurry)

Inorganic particles and a binder were mixed to fabricate a first-layer mixture. The inorganic particles were alumina (Al₂O₃) and the binder was polyvinylidene fluoride (PVDF). The mass ratio of the inorganic particles and binder was 95:5. This first-layer mixture was dispersed in N-methyl-2-pyrrolidone (NMP) to prepare a first-layer slurry.

The first-layer slurry obtained above was coated onto one surface of the first active material layer formed on the first conductor, while being adjusted to a thickness of 30 μm using an applicator. After coating, reduced-pressure drying was carried out at 90° C. for 12 hours. After reduced-pressure drying, a pressing treatment was performed at 300 kgf/cm to obtain the negative electrode of Example 1.

### (Cross-Sectional SEM Observation of Negative Electrode)

The cross-section of the obtained negative electrode was observed using cross-sectional SEM images of the negative electrode. Cross-sectional SEM observations were conducted on five visual fields from the obtained negative electrode, and the average thicknesses Tav of the first and second layers, the average thickness Uav of the first part, the average thickness Hav of the second part, the average particle diameter Rav of the active material, Hav/Rav, and the state of the areas of the first and second layers in the negative electrode were observed.

As a result of cross-sectional SEM observation, in one cross-sectional image, it was observed that the first layer 16α penetrated into the first active material layer 14α to form the second part 16αB. In the negative electrode of Example 1, the first layer 16α penetrated in a form covering the portion of the outermost particles closest to the first conductor (in a manner wrapping around to the back).

Likewise, cross-sectional SEM observation was conducted on four other different visual fields of the negative electrode and Tav, Uav, Hav, and Hav/Rav were calculated from the five images, and the average values of the five visual fields were determined.

The results of cross-sectional SEM observation for the following examples and comparative examples are shown in the table. In Example 10, although the average thickness of the second part was nearly zero, a part of the second part was present. In Example 9, although the average thickness of the second part was almost equal to zero, at least one portion in which the second part extended to a position beyond half the particle diameter was confirmed.

### (Fabrication of Lithium-Ion Secondary Battery for Evaluation)

The fabricated negative and positive electrodes were punched into predetermined strip shapes (negative electrode: 19 mm*23 mm, positive electrode: 18 mm*22 mm), and laminated alternately with a polypropylene separator having a thickness of 25 μm interposed therebetween, thereby fabricating a laminate of five negative electrodes and four positive electrodes.

In order to connect the terminal electrodes to both the positive and negative electrodes, an uncoated portion having a width of 1 mm was provided at the end portion where the positive-electrode active material layer and the first active material layer were not formed, and a nickel negative electrode lead was attached to the uncoated portion of the negative electrode that did not have the first active material layer, while in the positive electrode, an aluminum positive electrode lead was attached to the uncoated portion of the positive electrode that did not have the positive-electrode active material layer by an ultrasonic welder.

The laminate was inserted into an exterior body of aluminum laminate film, and all sides except one were heat-sealed to form an opening. Into the exterior body, a nonaqueous electrolyte solution was injected. The nonaqueous electrolyte solution was prepared by dissolving 1.5 mol/L of lithium hexafluorophosphate (LiPF₆) in a solvent composed of an equal-volume mixture of ethylene carbonate (EC) and propylene carbonate (PC). Also, the remaining portion was sealed by heat sealing while being depressurized with a vacuum sealer, thereby fabricating a lithium-ion secondary battery for evaluation according to the example.

### (Evaluation of Battery: Cycle Characteristics at 85° C.)

The cycle characteristics of the fabricated lithium-ion secondary battery for evaluation were assessed in an 85° C. environment using a secondary battery charge-discharge tester (manufactured by Hokuto Denko Co., Ltd.). The cycle characteristics were evaluated by repeating 500 charge/discharge cycles in which constant-current/constant-voltage charging was performed at 0.5 C to 4.35 V, and constant-current discharging was performed at 1 C to 2.8 V. The ratio of the discharged capacity after 500 cycles to the discharged capacity of the initial cycle was defined as the capacity retention rate. The capacity retention rate for the initial capacity is the discharge capacity of the 500th cycle when the discharge capacity of the initial (first) cycle is set to 100%.

### (Fabrication of Negative Electrodes According to Examples 2 to 9)

The negative electrodes for Examples 2 to 9 were fabricated under conditions similar to those in Example 1, except that the reduced-pressure drying time after coating the first-layer slurry was varied.

The time for reduced-pressure drying was 10 hours for Example 2, 8 hours for Example 3, 5 hours for Example 4, 3 hours for Example 5, 1 hour for Example 6, 30 minutes for Example 7, 10 minutes for Example 8, and 5 minutes for Example 9.

In addition, for Examples 4 to 9, additional drying was performed at 100° C. in air after reduced-pressure drying to completely remove the solvent component in the first layer.

### (Fabrication of Negative Electrode According to Example 10)

The negative electrode for Example 10 was fabricated under the similar conditions as in Example 1, except that reduced-pressure drying was not performed after coating the first-layer slurry, and drying was performed in air at 100° C.

### (Fabrication of Negative Electrode for Comparative Example 1)

The negative electrode for Comparative Example 1 was fabricated under conditions similar to those in Example 10, except that the first-layer slurry was not coated.

(Fabrication of Negative Electrode for Comparative Example 2: There is First Layer, but there is No Penetration Due to Post-Press Application)

The first-layer slurry was coated onto one surface of the first active material layer of the negative electrode fabricated in Comparative Example 1 (after pressing), and reduced-pressure drying was performed at 90° C. for 12 hours to fabricate the negative electrode for Comparative Example 2.

(Fabrication of Negative Electrode According to Example 11: Example in which First Layer is Located on First Active Material Layer and Second Layer is Located on Second Active Material Layer)

The first-layer slurry was coated onto one surface of the first active material layer formed on the first conductor, while being adjusted to a thickness of 20 μm using an applicator. After coating, reduced-pressure drying was performed at 90° C. for 3 hours. After reduced-pressure drying, additional drying was performed in air at 100° C. to remove the solvent from the first layer. That is, the drying conditions for the first layer were similar to those in Example 5.

The first-layer slurry was coated onto the second active material layer (the back side where a current collector is sandwiched), while being adjusted to a thickness of 20 μm using an applicator. After coating, reduced-pressure drying was performed at 90° C. for 12 hours. Subsequently, pressing was performed at 300 kgf/cm to obtain the negative electrode of Example 11, which included the second layer in addition to the first layer.

### (Fabrication of Negative Electrodes According to Examples 12 to 19)

The negative electrodes of Examples 12 to 19 were fabricated under conditions similar to those in Example 11, except that the time for reduced-pressure drying was changed when the second layer was fabricated on the second active material layer.

The time for reduced-pressure drying was 10 hours for Example 12, 8 hours for Example 13, 5 hours for Example 14, 3 hours for Example 15, 1 hour for Example 16, 30 minutes for Example 17, 10 minutes for Example 18, and 5 minutes for Example 19.

For Examples 14 to 19, additional drying was performed at 100° C. in air after reduced-pressure drying to completely remove the solvent component in the second layer.

### (Fabrication of Negative Electrode According to Example 20)

When the second layer was fabricated, the negative electrode of Example 20 was fabricated under conditions similar to those in Example 11, except that the second layer was not dried under reduced pressure but at 100° C. in air.

### (Fabrication of Negative Electrode According to Example 22)

The negative electrode of Example 22 was fabricated by coating the first-layer slurry on the second active material layer of the negative electrode produced in Example 21 (after pressing) and drying it under reduced pressure at 90° C. for 12 hours to fabricate the second layer.

### Examples 23 to 32: Examples Related to Wound Body

### (Basic Lithium-Ion Secondary Battery Preparation Method for Evaluation: Examples 23 to 32)

The fabricated negative and positive electrodes were punched into a specified long shape (negative electrode: 19 mm*160 mm, positive electrode: 18 mm*200 mm), two polypropylene separators having a thickness of 25 μm were arranged on both sides of the negative electrode, and the positive electrode was laminated on one side of the separator.

At this time, an uncoated portion without an active material layer was formed at the end of the negative electrode, and a nickel negative electrode lead was attached to the uncoated portion of the negative electrode without a negative-electrode active material layer. On the other hand, in the positive electrode, an uncoated portion without a positive-electrode active material layer was formed at both ends of the positive electrode, and an aluminum positive electrode lead was attached to one end of the uncoated portion of the positive electrode by an ultrasonic welder. The wound body was fabricated by winding the laminate with the side of the negative electrode that does not have the positive electrode laminated on it as the inner side. At this time, the ends with negative electrode leads were laminated so that the ends with negative electrode leads were on the inside of the winding and the ends with positive electrode leads were on the outside of the winding.

### (Fabrication of the Negative Electrode According to Example 23)

Using the negative electrode fabricated under conditions similar to those in Example 16, the wound body of Example 23 was fabricated so that the first layer of the negative electrode was inside the winding and the second layer was outside the winding when winding was performed.

### (Fabrication of Negative Electrode According to Example 24)

The wound body of Example 24 was fabricated under conditions similar to those in Example 23, except that the second layer of the negative electrode was inside the winding and the first layer was outside the winding when the winding was performed.

### (Fabrication of Negative Electrode According to Example 25)

Using a negative electrode fabricated under conditions similar to those in Example 15, except that when the first layer and the second layer were formed, the thickness of the first-layer slurry to be coated was adjusted to 10 μm using an applicator, a wound body of Example 25 was fabricated by winding so that the first layer of the negative electrode was inside the winding and the second layer was outside the winding when the winding was performed.

### (Fabrication of Negative Electrode According to Example 26)

The wound body of Example 26 was made under conditions similar to those in Example 25, except that the second layer of the negative electrode was wound so that the first layer was inside the winding and the second layer was outside the winding when the winding was performed.

### (Fabrication of Negative Electrode According to Example 27)

Using a negative electrode fabricated under conditions similar to those in Example 15, except that when the first layer and the second layer were formed, the thickness of the first-layer slurry to be coated was adjusted to 5 μm using an applicator, a wound body of Example 27 was fabricated by winding so that the first layer of the negative electrode was inside the winding and the second layer was outside the winding when the winding was performed.

### (Fabrication of Negative Electrode According to Example 28)

The wound body of Example 28 was made under conditions similar to those in Example 27, except that the second layer of the negative electrode was wound so that the second layer of the negative electrode was inside the winding and the first layer was outside the winding when the winding was performed.

### (Fabrication of Negative Electrode According to Example 29)

Using a negative electrode fabricated under conditions similar to those in Example 15, except that when forming the first layer, the thickness of the first-layer slurry to be coated was adjusted to 10 μm using an applicator, and when forming the second layer, the thickness of the first-layer slurry to be coated was adjusted to 5 μm using an applicator, a wound body of Example 29 was fabricated by winding so that the first layer of the negative electrode was inside the winding and the second layer was outside the winding when the winding was performed.

### (Fabrication of Negative Electrode According to Example 30)

A wound body of Example 30 was fabricated under conditions similar to those in Example 29, except that the second layer of the negative electrode was wound so that the second layer of the negative electrode was inside the winding and the first layer was outside the winding when the winding was performed.

### (Fabrication of Negative Electrode According to Example 31)

Using a negative electrode fabricated under conditions similar to those in Example 15, except that when forming the first layer, the thickness of the first-layer slurry to be coated was adjusted to 5 μm using an applicator, and when forming the second layer, the thickness of the first-layer slurry to be coated was adjusted to 8 μm using an applicator, a wound body of Example 31 was fabricated by winding so that the first layer of the negative electrode was inside the winding and the second layer was outside the winding when the winding was performed.

### (Fabrication of Negative Electrode According to Example 32)

A wound body of Example 32 was fabricated under conditions similar to those in Example 31, except that the second layer of the negative electrode was wound so that the second layer of the negative electrode was inside the winding and the first layer was outside the winding when the winding was performed.

The conditions and results of the examples and the comparative examples are shown in Tables 1 to 3.

TABLE 1

| | First layer | | | | | | |
|---|---|---|---|---|---|---|---|
| | | | Portion where | | | | |
| | | | second part | Portion where | Average | Average | Average |
| | | | extends to | second part | thickness | thickness | thickness |
| | | | position | wraps around | of first | of first | of second |
| | | | beyond half | to rear | layer | part | part |
| | First | Second | particle | side of | Tav | Uav | Hav |
| | layer | part | diameter | particle | (μm) | (μm) | (μm) |
| Example 1 | Present | Present | ◯ | ◯ | 62.4 | 3 | 59.4 |
| Example 2 | Present | Present | ◯ | ◯ | 58.8 | 3 | 55.8 |
| Example 3 | Present | Present | ◯ | ◯ | 57 | 3 | 54 |
| Example 4 | Present | Present | ◯ | ◯ | 40.8 | 3 | 37.8 |
| Example 5 | Present | Present | ◯ | ◯ | 24.6 | 3 | 21.6 |
| Example 6 | Present | Present | ◯ | ◯ | 12 | 3 | 9 |
| Example 7 | Present | Present | ◯ | ◯ | 8.4 | 3 | 5.4 |
| Example 8 | Present | Present | ◯ | ◯ | 6.6 | 3 | 3.6 |
| Example 9 | Present | Present | ◯ | X | — | 3 | — |
| Example 10 | Present | Present | X | X | — | 3 | — |
| Comparative Example 1 | Absent | Absent | — | — | — | — | — |
| Comparative Example 2 | Present | Absent | — | — | — | — | — |

| | First layer | | | |
|---|---|---|---|---|
| | | Average | | |
| | | particle | | |
| | | diameter | | |
| | | of active | | |
| | Surface length of first layer in cross- | material | | Evaluation |
| | sectional image | Rav | | Cycle |
| | (Opposite side of conductor, conductor side) | (μm) | Hav/Rav | characteristic |
| Example 1 | Opposite side of conductor < Conductor side | 18 | 3.3 | 68 |
| Example 2 | Opposite side of conductor < Conductor side | 18 | 3.1 | 67 |
| Example 3 | Opposite side of conductor < Conductor side | 18 | 3.0 | 73 |
| Example 4 | Opposite side of conductor < Conductor side | 18 | 2.1 | 73 |
| Example 5 | Opposite side of conductor < Conductor side | 18 | 1.2 | 78 |
| Example 6 | Opposite side of conductor < Conductor side | 18 | 0.5 | 79 |
| Example 7 | Opposite side of conductor < Conductor side | 18 | 0.3 | 74 |
| Example 8 | Opposite side of conductor < Conductor side | 18 | 0.2 | 66 |
| Example 9 | Opposite side of conductor < Conductor side | 18 | — | 62 |
| Example 10 | Opposite side of conductor < Conductor side | 18 | — | 59 |
| Comparative Example 1 | — | 18 | — | 33 |
| Comparative Example 2 | Opposite side of conductor = Conductor side | 18 | — | 31 |

TABLE 2

| | Second layer | | | | | | |
|---|---|---|---|---|---|---|---|
| | | | Portion where | | Average | Average | Average |
| | | | fourth part | Portion where | thickness | thickness | thickness |
| | | | extends to | fourth part | of second | of third | of fourth |
| | | | position beyond | wraps around to | layer | part | part |
| | Second | Fourth | half particle | rear side of | T′av | U′av | H′av |
| | layer | part | diameter | particle | (μm) | (μm) | (μm) |
| Example 11 | Present | Present | ◯ | ◯ | 61.4 | 3 | 59.4 |
| Example 12 | Present | Present | ◯ | ◯ | 57.8 | 3 | 55.8 |
| Example 13 | Present | Present | ◯ | ◯ | 56 | 3 | 54 |
| Example 14 | Present | Present | ◯ | ◯ | 39.8 | 3 | 37.8 |
| Example 15 | Present | Present | ◯ | ◯ | 23.6 | 3 | 21.6 |
| Example 16 | Present | Present | ◯ | ◯ | 11 | 3 | 9 |
| Example 17 | Present | Present | ◯ | ◯ | 7.4 | 3 | 5.4 |
| Example 18 | Present | Present | ◯ | ◯ | 5.6 | 3 | 3.6 |
| Example 19 | Present | Present | ◯ | X | — | 3 | — |
| Example 20 | Present | Present | X | X | — | 3 | — |
| Example 22 | Present | Absent | — | — | — | — | — |

| | Second layer | | | |
|---|---|---|---|---|
| | | Average | | |
| | | particle | | |
| | | diameter | | |
| | | of active | | |
| | Surface length of second layer in cross- | material | | Evaluation |
| | sectional image | R′av | H′av/ | Cycle |
| | (Opposite side of conductor, conductor side) | (μm) | R′av | characteristic |
| Example 11 | Opposite side of conductor < Conductor side | 18 | 3.3 | 88 |
| Example 12 | Opposite side of conductor < Conductor side | 18 | 3.1 | 87 |
| Example 13 | Opposite side of conductor < Conductor side | 18 | 3.0 | 90 |
| Example 14 | Opposite side of conductor < Conductor side | 18 | 2.1 | 92 |
| Example 15 | Opposite side of conductor < Conductor side | 18 | 1.2 | 93 |
| Example 16 | Opposite side of conductor < Conductor side | 18 | 0.5 | 91 |
| Example 17 | Opposite side of conductor < Conductor side | 18 | 0.3 | 91 |
| Example 18 | Opposite side of conductor < Conductor side | 18 | 0.2 | 86 |
| Example 19 | Opposite side of conductor < Conductor side | 18 | X | 85 |
| Example 20 | Opposite side of conductor < Conductor side | 18 | X | 81 |
| Example 22 | Opposite side of conductor < Conductor side | 18 | — | 77 |

TABLE 3

| | Average | Average | | |
|---|---|---|---|---|
| | thickness | thickness | | |
| | of first | of second | | |
| | layer | layer | Inside of | Cycle |
| | Tav | T′av | winding | characteristic |
| Example 23 | 10 μm | 10 μm | First layer | 81 |
| Example 24 | 10 μm | 10 μm | Second layer | 80 |
| Example 25 | 5 μm | 5 μm | First layer | 82 |
| Example 26 | 5 μm | 5 μm | Second layer | 84 |
| Example 27 | 1 μm | 1 μm | First layer | 80 |
| Example 28 | 1 μm | 1 μm | Second layer | 83 |
| Example 29 | 5 μm | 1 μm | First layer | 79 |
| Example 30 | 5 μm | 1 μm | Second layer | 84 |
| Example 31 | 1 μm | 3 μm | First layer | 85 |
| Example 32 | 1 μm | 3 μm | Second layer | 77 |

### REFERENCE SIGNS LIST

10 Negative electrode, 12 First conductor, 12a First surface, 12b Second surface, 14α First active material layer, 14β Second active material layer, 14P1 (14P) Negative-electrode active material particle (first negative-electrode active material particle), 14P2 (14P) Negative-electrode active material particle (second negative-electrode active material particle), 16α First layer, 16αA First part, 16αB Second part, 16β Second layer, 16βA Third part, 16βB fourth part, 16αAS, 16αBS, 16αBS, 16βBS Surface, 20 Separator, 30 Positive electrode, 90 Laminate, 90C Curved portion, 90M Flattened portion, 100 Power storage element, dp Particle diameter, VV Gap

1. A power storage element comprising a negative electrode, the negative electrode comprising:
a first conductor having a first surface and a second surface opposite to the first surface;
a first active material layer provided on the first surface of the first conductor and comprising a plurality of first negative-electrode active material particles; and
a first layer containing an inorganic material, the first layer having a first part provided across two or more first negative-electrode active material particles exposed on an opposite side of the first conductor in the first active material layer and a second part penetrating, from the first part, between the first negative-electrode active material particles of the first active material layer.

2. The power storage element according to claim 1, wherein a length of a surface of a first layer on a first conductor side is greater than a length of a surface on the opposite side of the first conductor of the first layer in a cross-sectional image along a first direction in which the first active material layer and the first conductor are aligned.

3. The power storage element according to claim 1, wherein the second part of the first layer extends from the first part to a position beyond half of a particle diameter of at least one first negative-electrode active material particle exposed on the opposite side of the first conductor in a first direction where the first active material layer and the first conductor are aligned.

4. The power storage element according to claim 1, wherein the second part of the first layer extends from the first part to a position covering a portion closest to the first conductor of at least one first negative-electrode active material particle exposed on the opposite side of the first conductor in a first direction where the first active material layer and the first conductor are aligned.

5. The power storage element according to claim 1, wherein when an average thickness of the second part of the first layer in a cross-sectional image along a first direction where the first active material layer and the first conductor are aligned is denoted by Hav and an average particle diameter of the plurality of first negative-electrode active material particles included in the first active material layer is denoted by Rav, 0.3≤Hav/Rav≤3.0 is satisfied.

6. The power storage element according to claim 5, wherein 0.3≤Hav/Rav≤3.0 is satisfied in a plurality of cross-sectional images.

7. The power storage element according to claim 5, wherein 0.5≤Hav/Rav≤2.0 is satisfied.

8. The power storage element according to claim 1, wherein the inorganic material is an inorganic compound.

9. The power storage element according to claim 8, wherein the inorganic compound includes aluminum oxide.

10. The power storage element according to claim 1, wherein the first layer further includes an organic compound.

11. The power storage element according to claim 10, wherein the organic compound includes a fluorine-containing polymer compound.

12. The power storage element according to claim 11, wherein the polymer compound is polyvinylidene fluoride.

13. The power storage element according to claim 10, wherein a mass ratio of the inorganic material to the organic compound is 1:1 to 100:1.

14. The power storage element according to claim 1, wherein the negative-electrode active material particles of the first active material layer contain at least one of carbon materials, metals, metal oxides, semi-metals, and semi-metal oxides.

15. The power storage element according to claim 1, wherein the negative electrode further includes
a second active material layer provided on the second surface of the first conductor and containing a plurality of second negative-electrode active material particles; and
a second layer containing an inorganic material and including a third part provided across two or more second negative-electrode active material particles exposed on the opposite side of the first conductor in the second active material layer and a fourth part penetrating between the second negative-electrode active material particles of the second active material layer from the third part.

16. The power storage element according to claim 15, wherein the fourth part of the second layer extends from the third part to a position beyond half of a particle diameter of at least one second negative-electrode active material particle exposed on the opposite side of the first conductor in a second direction where the second active material layer and the first conductor are aligned.

17. The power storage element according to claim 15, wherein the fourth part of the second layer extends from the third part to a position covering the portion closest to the first conductor of at least one second negative-electrode active material particle exposed on the opposite side of the first conductor in a second direction where the second active material layer and the first conductor are aligned.

18. The power storage element according to claim 15, wherein a thickness, in a first direction in which the first active material layer and the first conductor are aligned, of the first part of the first layer, and a thickness, in a second direction in which the second active material layer and the first conductor are aligned, of the third part of the second layer, are different from each other.

19. The power storage element according to claim 15, wherein a thickness, in a first direction in which the first active material layer and the first conductor are aligned, of the first part of the first layer is greater than a thickness, in a second direction in which the second active material layer and the first conductor are aligned, of the third part of the second layer.

20. The power storage element according to claim 1, further comprising a positive electrode and a separator arranged between the negative electrode and the positive electrode.

21. The power storage element according to claim 15, further comprising;
a positive electrode; and
a separator arranged between the negative electrode and the positive electrode,
wherein a laminate having the negative electrode, the separator, and the positive electrode is wound.

22. The power storage element according to claim 21, wherein the laminate is wound so that the second layer is inside the first layer.

23. The power storage element according to claim 22, wherein a thickness of the second layer is less than a thickness of the first layer.

24. The power storage element according to claim 21,
wherein the laminate is wound so that flattened portions and curved portions are alternately provided, and
wherein a thickness of the first layer of the curved portion is less than a thickness of the first layer of the flattened portion.
